(19) United States
(12) Patent Application Publication
(10) Pub. No.: US 2007/0144300 A1
(43) Pub. Date: Jun. 28, 2007

(54) UNIVERSAL JOINT

(75) Inventor: Toshio Furusawa, Kawasaki-shi (JP)

Correspondence Address: WOLF, BLOCK, SHORR AND SOLIS-COHEN LLP, 250 PARK AVENUE, 10TH FLOOR, NEW YORK, NY, 10177, US

(73) Assignee: Mitsuya Laboratories Inc., Kawasaki-shi (JP)

(21) Appl. No.: 11/567,280

(22) Filed: Dec. 6, 2006

(30) Foreign Application Priority Data
Dec. 28, 2005 (JP) 2005-379659

(51) Int. Cl. B62D 1/20

(52) U.S. Cl. 74/496

(57) ABSTRACT

Prevention of movement of the rotational center of a spherical member provided at one end of a rotary shaft is achieved with an inexpensive structure. A universal joint is equipped with a rotary shaft 21 having a spherical member 22 provided at one end and having a pair of shafts 24 provided on the diameter line of the spherical member 22; and a rotating body 26 having guide grooves 28 formed therein for receiving the shafts of the rotary shaft, and a holding cage 27 formed therein for trapping the spherical member 22, the spherical member rotating about the axis of the shafts and also rotating while tilting the shafts along the guide grooves. Raised portions 30 are provided in the holding cage for preventing the spherical member from falling out of position.

### BACKGROUND OF THE INVENTION

1. Field of the Invention

This invention relates to a universal joint having a rotating shaft and a rotating body which allow movement in all directions.

2. Description of the Related Art

FIG. 7 to FIG. 11 illustrated and example of conventionally known universal joints as described above, which includes a rotary shaft 1 provided with spherical members 2, 3 at two ends, respectively. The spherical member 2 has a pair of shafts 4 extending on its diameter line at right angles to the rotary shaft 1, and likewise the spherical member 3 has a pair of shafts 5.

In turn, the rotary shaft 1 is coupled to rotating bodies 6, 7 that are each formed in a tubular shape and respectively have holding cages 8, 9 formed on their axes. The holding cage 8, 9 respectively hold the spherical members 2, 3 movably in the axis direction thereof. The rotating body 6 further has a pair of guide grooves 10 extending in the axis direction in positions 180 degrees out of phase with each other, and likewise the rotating body 7 further has a pair of guide grooves 11. The two pairs of guide grooves 10, 11 respectively receive slidably the pairs of shafts 4, 5 of the spherical members 2, 3 held in the holding cages 8, 9.

The insertion of the spherical members 2, 3 in the holding cages 8, 9 enables the rotation of the spherical members 2, 3 about the axis line of the shafts 4, 5 and also during the tilting of the shafts 4, 5 in the guide grooves 10, 11. The rotary shaft 1 is thus rotatable in all directions with respect to the rotating bodies 6, 7.

One example of the use of the universal joint designed in this way is its use to couple a drive shaft to an output shaft of a radio-controlled car. In order to couple the drive shaft to the output shaft of the radio controlled car, the rotating body 6 is coupled to the drive shaft as shown in FIG. 9. Specifically, the rotating body 6 is attached via bearings 14, 15 to a ring 13 formed in a knuckle arm 12 in the steering system connected to the drive wheels. Then, the drive wheel 17 is fixed to the axle 16 provided integrally with the rotating body 6. As a result, as the rotary shaft 1 rotates, the rotating body 6 rotates, causing the drive wheel 17 to rotate with it. The knuckle arm 12 moves rotationally in the directions of the arrows 18 shown in FIG. 9, around a point X which is the center of a kingpin (not shown).

On the other hand, the rotating body 7 located opposite to the rotating body 6 is coupled to the output system (not shown) and rotates in conjunction with the output system. The torque of the rotating body 7 rotating along with the output system is transmitted through the rotary shaft 1 to the counterpart rotating body 6. The torque, which has been transmitted to the rotating body 6 in this manner, is transferred also to the drive wheel 17 to produce the rotation of the drive wheel 17. At this point, if the knuckle arm 12 moves rotationally in either of the directions of the arrows 18, the drive wheel 17 is changed in direction.

When the rotating body 6 rotates about the rotating body 7, the virtual distance between the rotating bodies 6, 7 increases. For example, when the rotating bodies 6, 7 are on the same axis, the distance between the rotating bodies 6, 7 is L1 as shown in FIG. 10. When rotating bodies 6, 7 are on the same axis, the rotational center X of the rotating body 6 and the rotational center of the spherical member 2 are aligned with each other.

However, when the rotating body 6 rotates about the rotating body 7, the distance between the rotating bodies 6, 7 becomes L2 as shown in FIG. 11. The distance L2 becomes longer than the distance L1. However, even if the distance between them increases from L1 to L2, because the rotary shaft 1 is not extendable, the spherical members 2, 3 retained in the holding cages 8, 9 of the rotating bodies 6, 7 move in the axis direction, thereby absorbing the difference between the distance L1 and L2.

Incidentally, no examination has specially been made for the conventional example.

Regarding conventional universal joints structured as described above, for example, when the rotating body 6 rotates about the rotating body 7, the distance between the rotating bodies 6, 7 is increased by the length “L2−L1”. For example, it is assumed that the increased length is absorbed in the rotating body 6. If the rotating body 6 absorbs the increased length in this manner, the rotational center Y of the spherical member 2 becomes out of alignment with the rotational center X of the rotating body 6 as shown in FIG. 11.

The misalignment caused between the rotational center X of the rotating body 6 and the rotational center Y of the spherical member 2 makes it impossible to for the rotating body 6 to rotate about the center X. Still, the knuckle arm 12 continues to rotate about the center X in order to change the traveling direction of the drive wheel 17. At this point, the rotating body 6 rotates while pulling the rotational center Y of the spherical member 2 toward the rotational center X. In other words, the rotating body 6 rotates while moving the rotary shaft 1 toward the rotating body 6 in such a manner as to draw the spherical member 3 located at the other end of the rotary shaft 1 out from the holding cage 9 of the rotating body 7.

Such rotation of the rotating body 6 while pulling the spherical member 2 increases the resistance, resulting in the impossibility of a smooth change in the traveling direction of the drive wheel 17. Further, every time the traveling direction of the drive wheel 17 is changed, the rotary shaft 1 moves in the axis direction. This also makes a smooth change in the traveling direction of the drive wheel 17 difficult.

In the foregoing example, the steering mechanism and the drive mechanism for the drive wheel 17 are combined to systematically rotate the rotating body 6 of the two rotating bodies about the center X. However, the aforementioned conventional universal joint also has a problem as similar to that described above even when the rotation of the rotating body is caused as a consequence, not caused systematically.

The problems described in the foregoing do not arise if the rotational center Y of the spherical member 2 held in the holding cage 8 and the rotational center X of the rotating body 6 are in alignment with each other at all times. However, in view of the cost advantages, the conventional universal joint as described above is not designed such that the rotational center 7 of the spherical member 2 in the holding cage 8 and the rotational center X of the rotating body 6 are systematically aligned with each other. In order to achieve the positional alignment between the rotational center Y of the spherical member 2 in the holding cage 8 and the rotational center X of the rotating body 6, this type of inexpensive universal joint is considered incompetent, and the use of a higher precision universal joint is considered necessary.

Further, the holding cage 8 needs to be deepened for ensuring the amount of movement of the center Y of the spherical member 2. However, when the spherical member 2 is positioned close to the closed end of the holding cage 8, if the rotary shaft 1 moves at an angle with respect to the rotating body 6, the rotary shaft 1 is disadvantageously pressed against the opening edge of the holding cage 8, resulting in damage to the opening edge.

### SUMMARY OF THE INVENTION

It is an object of the present invention to provide a universal joint of an inexpensive form capable of inserting a spherical member into a holding cage while maintaining a spherical member in position in a holding cage.

The present invention is based on a universal joint that is provided with a rotary shaft having a spherical member provided at one end and having a pair of shafts provided on the diameter line of the spherical member; and a rotating body having guide grooves formed therein for receiving the shafts of the rotary shaft, and a holding cage formed therein for trapping the spherical member, in which the spherical member is provided rotatably about the axis of the shafts and also rotatably while tilting the shafts along the guide grooves.

Based on the above universal joint, a feature of the present invention is that raised portions are formed in the holding cage of the rotating body by performing a punching process on the outer periphery of the rotating body for preventing the spherical member from falling out from the holding cage; and a jig stage is formed at the open end of the holding cage in the circumferential direction of the open end for receiving a jig used in the punching process.

A second feature of the present invention is that O-ring grooves are formed in the outer periphery surface of the rotating body for receiving an O ring and have open ends formed in parts of the bottom portions of the O-ring grooves to allow the O ring to protrude from the open ends of the ring grooves to the inside of the holding cage, so that the protruding portions of the O ring prevents the spherical member from falling out of the holding cage, and the bottom of each of the ring grooves is formed in an arc shape having a curvature greater than the curvature of the inner surface of the holding cage.

A third feature of the present invention is that through holes are formed in the rotating body, and balls are respectively inserted in the through holes and protrude from an open end of the through holes to the inside of the holding cage, so that the protruding portions of the balls prevent the spherical member from falling out of the holding cage.

According to the present invention, because the raised portions specify the position of the spherical member in the holding cage, this makes it possible to align at all times the rotational center of the spherical member and the rotational center of either the rotating body of a bearing or the like mounted on the rotating body. Accordingly, when the universal joint of the present invention is used as, for example, a drive shaft of a drive wheel with a steering mechanism in a radio-control car, the rotational center of the spherical member is aligned with the position of the kingpin provided on the knuckle arm at all times, resulting in a significant smooth change in the traveling direction of the drive wheel.

Further, low cost is a feature of such a type of universal joint. Without loss of this “low cost”, the present invention is capable of reliably solving the conventional disadvantageous problems. That is, by placing the spherical member in the rotating body used in the conventional joint and then simply performing the punching process on the rotating body from the outside, a satisfactory improvement in performance is achieved, resulting in an immeasurable cost advantage.

Still further, the jig stage is provided at the open end of the holding cage in order to prevent deformation of the rotating body in the punching process. Accordingly, even if a quite large force is applied to the rotating body in the process, the rotating body is not deformed. In consequence, it is possible to maintain a smooth rotation of the spherical member at all times.

According to the second feature of the present invention, a simple process for fitting the O ring into the ring grooves enables the specifying of the position of the spherical member and the prevention of the spherical member from falling out of position. Accordingly, by forming the ring grooves, the assembly process of the universal joint is significantly facilitated.

According to the third feature of the present invention, by simply inserting the balls in the pre-formed through holes, the assembly process of the universal joint is significantly facilitated as in the case of the second feature.

### BRIEF DESCRIPTION OF THE DRAWINGS

FIG. 1 is a sectional view illustrating the mounting of the universal joint in a first embodiment according to the present invention.

FIG. 2 is a sectional view illustrating the rotating body in the first embodiment.

FIG. 3 is a diagram illustrating the process for forming a raised portion in the rotation body in the first embodiment.

FIG. 4 is a perspective view with a partial cross section in a second embodiment.

FIG. 5 is a sectional view illustrating the installation of an O ring in the second embodiment

FIG. 6 is a perspective view with a partial cross section in a third embodiment.

FIG. 7 is a front view illustrating a conventional universal joint.

FIG. 8 is a perspective view illustrating a spherical member provided at the end of a conventional rotary shaft.

FIG. 9 is a partially sectional view illustrating a conventional universal joint coupled to a drive wheel connected to the steering mechanism of a radio-controlled car.

FIG. 10 is a sectional view illustrating a pair of rotating bodies positioned on the same axis, in the conventional universal joint

FIG. 11 is a sectional view illustrating the position of the pair of rotating bodies after one of them has rotated, in the conventional universal joint.

### DETAILED DESCRIPTION OF THE PREFERRED EMBODIMENTS

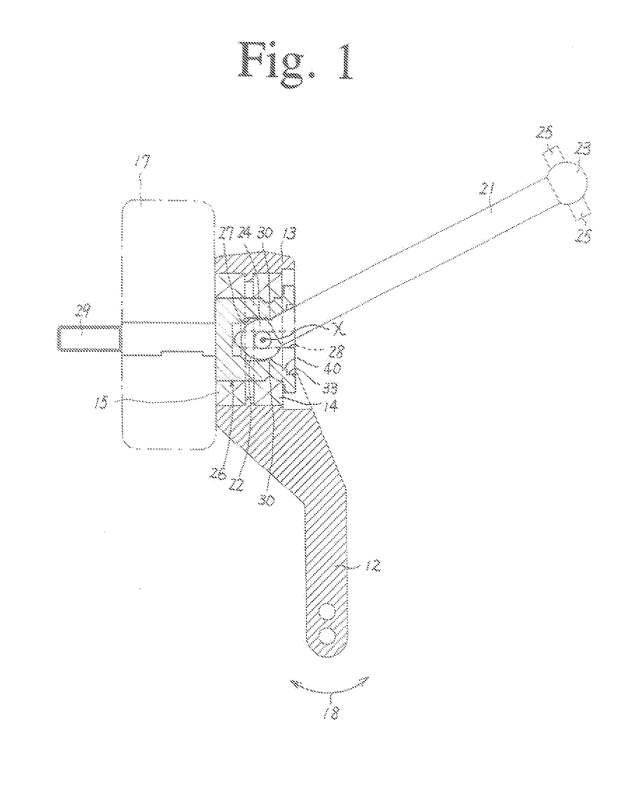

FIG. 1 to FIG. 3 illustrate a first embodiment of the universal joint according to the present invention as used in a radio-controlled car. In FIG. 1, a rotary shaft 21 has spherical members 22, 23 respectively provided at the two ends. The spherical member 22, 23 has respective pairs of shafts 24, 25 provided on their diameter lines in a direction at right angles to the axis of the rotary shaft 21. The two ends of the rotary shaft 21 are respectively coupled to rotating bodies of which one rotating body 26 has features of the present invention, and the other rotating body is the same as that conventionally used. Therefore, a description of the other rotating body is omitted and, when required, a description will be given using the same reference numerals as those in the conventional example described earlier.

The rotating body 26 is formed in a tubular shape having a holding cage 27 formed on the axis line. The holding cage 27 receives the spherical member 22. The rotating body 26 has a pair of guide grooves 28 extending in the axis direction in positions 180 degrees out of phase with each other, as in the conventional case. The guide grooves 28 movably receive the shafts 24 of the spherical member 22 placed in the holding cage 27.

The insertion of the spherical member 22 in the holding cage 27 as described above enables the rotation of the spherical member 22 about the axis line of the shafts 24 and also during the tilting of the shafts 24 in the guide grooves 28. The rotary shaft 21 is thus rotatable in any direction with respect to the rotating body 26. In addition, a tapered face 40 is formed on the open end of the rotating body 26 in such a manner as to increase in diameter toward the outside, in order to achieve a proper inclination of the rotary shaft 21.

The universal joint structured as described above is used in, for example, a radio-controlled car, and, together with the steering mechanism, is coupled a drive wheel to the output shaft and the like. This use is the same as that described in the conventional example, and the structural components of the steering mechanism and the drive mechanism are described by use of the same reference numerals as those in the conventional example.

As illustrated in FIG. 1, the rotating body 26 is coupled to a drive wheel 17. Specifically, the rotating body 26 is coupled through bearings 14, 15 in a ring portion 13 which is formed in a knuckle arm 12 in the steering system connected to the drive wheel 17. Thus, the drive wheel 17 is fixed to an axle 29 provided integrally with the rotatvie body 26. Accordingly, upon the rotation of the rotary shaft 21, the rotating body 26 rotates and in turn the drive wheel 17 rotates with it. The knuckle arm 12 moves rotationally in directions of the arrows 18 shown in FIG. 1, and the center of the rotational motion is a point X corresponding to the center of the kingpin (not shown).

The other rotating body 7 located opposite the rotating body 26 is connected to the output system (not shown) as in the case of the conventional example and rotates in conjunction with the output system. Therefore, the rotating body 7 rotates along with the output system and the torque of the rotating body 7 is transmitted through the rotary shaft 21 to the rotating body 26. After the torque is transmitted to the rotating body 26, the torque is transferred to the drive wheel 17 to produce rotation of the drive wheel 17. At this point, if the knuckle arm 12 moves rotationally in either of the directions of the arrows 18, the traveling direction of the drive wheel 17 is changed.

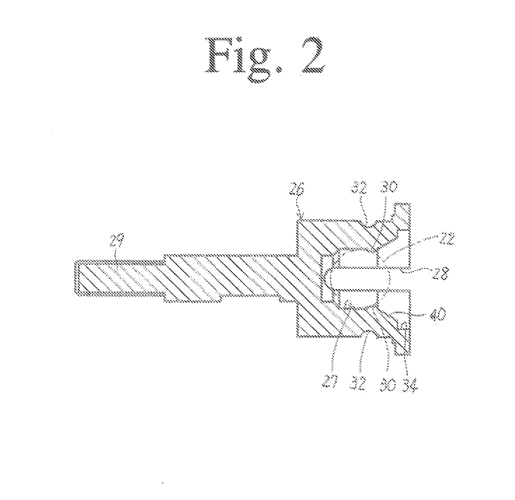

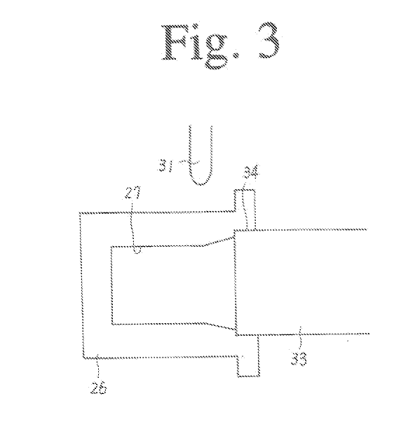

As is clear from FIG. 1 and FIG. 2, the rotating body 26 structured as described above has a pair of raised portions 30 formed inside the holding case 27 of the rotating body 26. The pair of raised portions 30 are symmetrically positioned 180 degrees out of phase with each other in the circumferential direction of the rotating body 26. To form the raised portion 30, the punching process using a punch 31 is performed as is seen from FIG. 3. Specifically, the punch 31 strikes the outer periphery of the rotating body 26 to form recesses 32 in the outer peripheral surface so as to cause the raised portions 30 to protrude from the inner surface of the holding cage 27 corresponding to the recesses 32.

If the tubular rotating body 26 is subjected directly to the punching process, the rotating body 26 will necessarily be deformed. To avoid this, a column-shaped or cylindrical-shaped jig 33 is used. For using the jib 33, a jig stage 34 is formed on the open end of the rotating body 26 in the circumferential direction. The jig stage 34 has an inner diameter determined in the dimensional relationship in which the jig 33 can be appropriately fitted into the jig stage 34.

When the jig 33 is appropriately fitted into the jig stage 34 as shown in FIG. 3, if the punch 31 strikes predetermined positions of the outer periphery face of the rotating body 26, the raised portions 30 are formed on the positions in the holding cage 27 corresponding to the positions struck by the punch 31 as shown in FIGS. 1 and 2. At this point, because the jig 33 is fitted into the fig step 34, the rotating body 26 is not deformed by the impact produced by the striking of the punch 31. Since the rotating body 26 is not deformed, the spherical member 22 is able to smoothly rotate in the holding cage 27.

The raised portions 30 formed as described above exert the function of preventing the spherical member 22 from falling out of position by making contact with the spherical member 22 in the holding cage 27. Also the spherical member 22 is held in position by the raised portions 30. As a result, the rotational center X of the knuckle arm 12 and the rotational center Y of the spherical member 22 are aligned in the determined position.

Accordingly, even if the knuckle arm 12 rotates about the kingpin, the center of the relative rotation between the spherical member 22 and the rotating body 26 is not displaced. Because there is not displacement of the relative rotational center, the knuckle arm 12 smoothly rotates about the kingpin. In other words, all inconveniences caused by a misalignment between the rotational centers of the rotating body 26 and the spherical member 22 as occurring in the conventional example are eliminated. In the first embodiment, the rotating body 26 has the raised portion 30 formed therein to trap the spherical member 22 therein, whereas the other rotating body 7 is designed as in the case of the conventional example. In consequence, when the knuckle arm 12 rotates and the distance between the rotating body 26 and the rotating body 7 changes from L1 to L2 as described earlier, the change is completely absorbed by the rotating body 7.

According to the first embodiment, because there is no necessity of ensuring the amount of movement of the center Y of the spherical member 2 as in done conventionally, the need for increasing the depth of the holding cage 27 is also eliminated. As a result, the open end of the holding case 27 and the raised portions 10 can be positioned close to each other. This makes it possible for an allowable angle of relative rotational movement between the rotary shafts 21 and the rotating body 26 to be set large. If the allowable angle of relative rotational movement can be increased in this manner, even when the rotary shaft 21 and the rotating body 26 greatly move rotationally relative to each other, the rotary shaft 21 will not cause any damage to the open end of the holding cage 27.

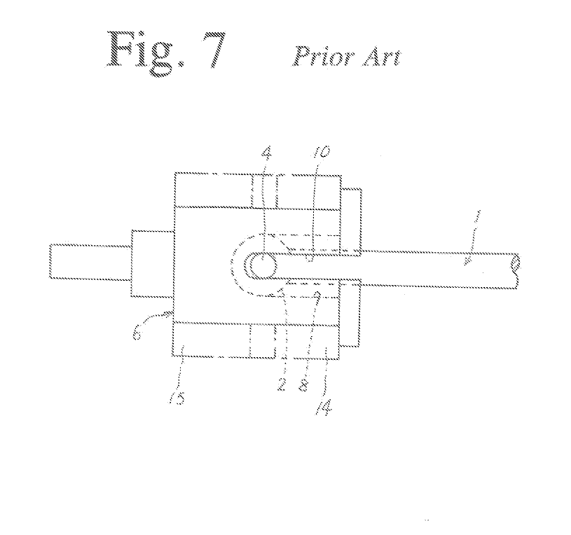

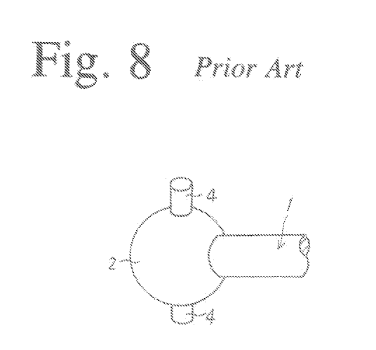

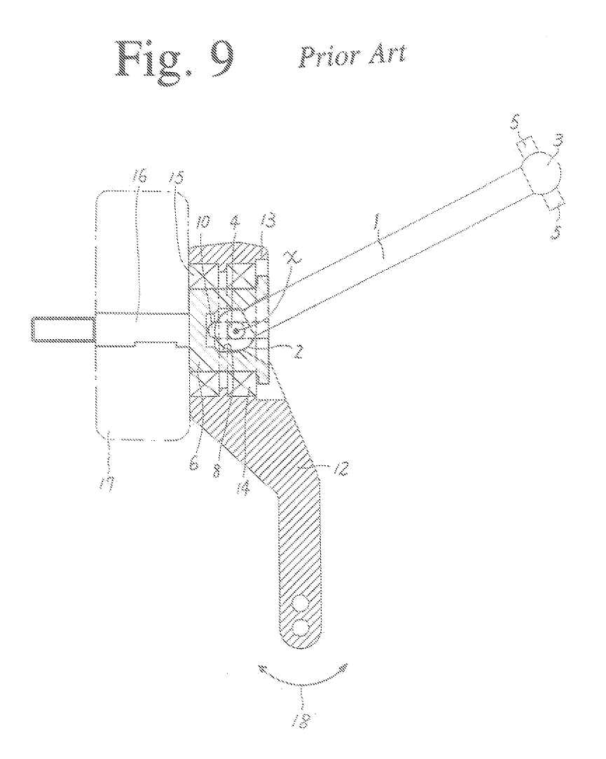

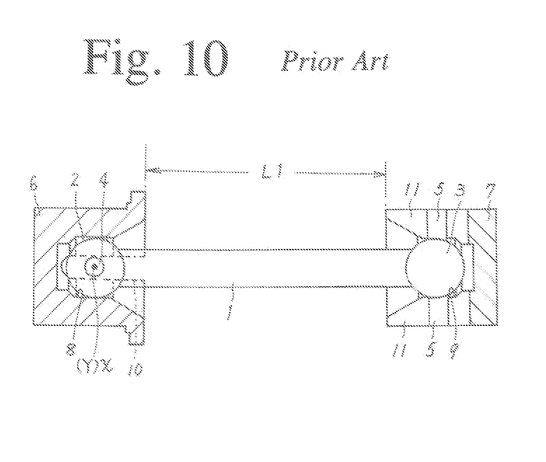

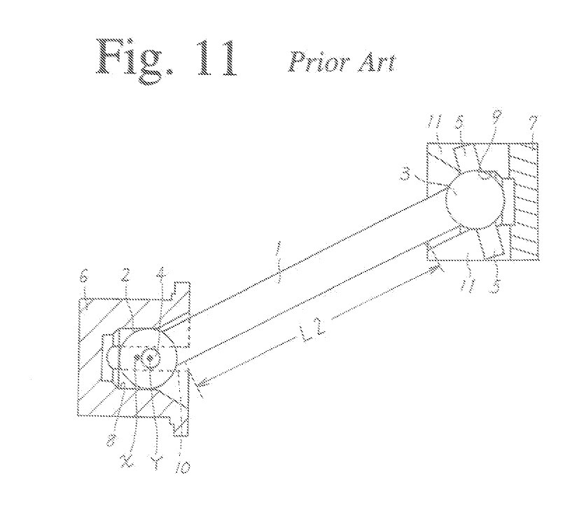

Because of the simple process of placing the spherical member 22 in the holding cage 27 of the rotating body 26 and performing the punching process to form the raised portions 30 for preventing the spherical member 22 from falling out of position, the present invention is able to reliably eliminate the disadvantages of the conventional universal joint illustrated in FIG. 7 to FIG. 11 while still satisfactorily offering the advantage of low cost thereof.

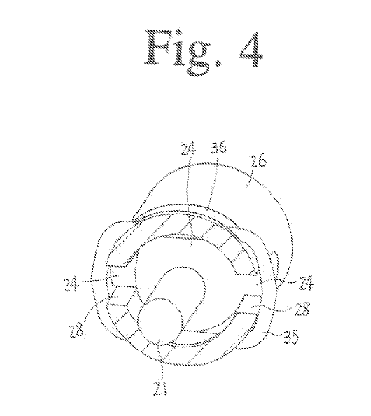

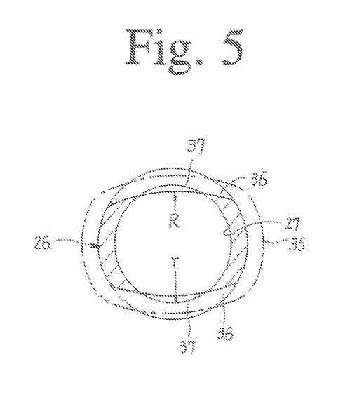

FIGS. 4 and 5 illustrate a second embodiment of the present invention which uses an O ring 35 having an inner diameter sufficiently smaller than the outer diameter of the rotating body 26, instead of the raised portions 30 in the first embodiment. Specifically, as shown in FIG. 5, a pair of ring grooves 36 extends in the outer periphery of the rotating body 26 in the circumferential direction. The ring grooves 36 are situated symmetrically 180 degrees out of phase in the circumferential direction of the rotating body 26. In addition, each of the ring grooves 36 has an open end 37 formed in the center of the bottom portion facing the inside of the holding cage 27. The bottom portion of each of the ring grooves 36 is formed in an arc shape. The curvature R of the arc of the bottom portion is larger than the curvature r of the inner face of the holding cage 27.

Therefore, while being sufficiently enlarged, the O ring 35 is fitted over the outer periphery of the rotating body 26, and then moved along the outer periphery of the rotating body 26 to be fitted into the ring grooves 36 for engagement. By engaging the O ring 35 with the ring grooves 36, the O ring 35 protrudes from the open ends 37 to the holding cage 27. The O ring 35 thus protruding from the open ends 37 to the holding cage 27 functions, as in the case of the raised portions 30 of the first embodiment, to prevent the spherical member 22 from falling out of the holding cage 27.

The bottom of each of the ring grooves 36 in the second embodiment is formed in an arc shape having a curvature R greater than the curvature r of the holding cage 27, so that the O ring 35 in the ring grooves 36 is not required to be stretched in a straight line. If the bottom of each of the ring grooves 36 is shaped linearly parallel to the diameter line, the O ring 35 in the ring grooves 36 is required to be sufficiently stretched continuously in a straight line in order to protrude from the open ends 37. This is because the O ring 35 does not protrude from the open ends 37 if the O ring 35 slightly sags in the ring grooves 36 to form an arc.

Further, in order to maintain the straight line form of the O ring 35 in the ring grooves 36 as described above, the application of a sufficient tension to the O ring 35 is necessary. In order to apply a sufficient tension to the O ring 35, it is necessary to make the inner diameter of the O ring 35 sufficiently smaller than the outer diameter of the rotating body 26. However, the smaller the inner diameter of the O ring 35, in turn the easier it is for the O ring 35 not to be engaged. Actually, it is close to impossible to stretch the O ring 35 to a degree in which it protrudes from the open ends 37.

However, when as in the second embodiment, each of the ring grooves 36 has an arc-shaped bottom portion and the curvature R of the arch shape is greater than the curvature r of the inner surface of the holding cage 27, the O ring 35 is able to be appropriately fitted along the bottom of the ring grooves 36 and protrude from the open ends 37 to the holding cage 27 without being so stretched.

The second embodiment differs from the first embodiment in the use of the O ring 35 instead of the raised portions 30 in the first embodiment, and the remaining structure of the second embodiment is the same as that of the first embodiment. Accordingly, a description of the same structure is omitted.

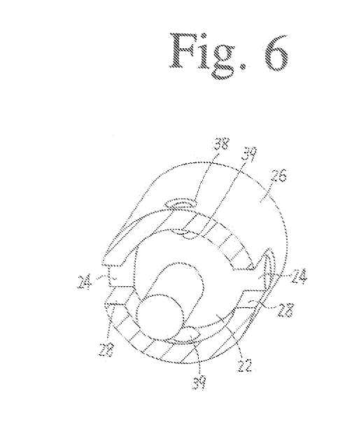

FIG. 6 illustrates a third embodiment, in which a pair of through holes 38 is provided in symmetrical positions 180 degrees out of phase with each other in the circumferential direction of the rotating body 26. Balls 39 are placed in the respective through holes 38. The balls 39 are prevented from falling out of the through holes 18 by inserting the rotating body 26 into the bearing 14. The balls 39 thus mounted have the same functions as that of the raised portions 30 of the first embodiment.

1. A universal joint, comprising:
a rotary shaft having a spherical member provided at one end and having a pair of shafts provided on the diameter line of the spherical member; and
a rotating body having guide grooves formed therein for receiving the shafts of the rotary shaft, and a holding cage formed therein for trapping the spherical member, the spherical member rotating about the axis of the shafts and also rotating while tilting the shafts along the guide grooves,
wherein raised portions are formed in the holding cage of the rotating body by performing a punching process on the outer periphery of the rotating body for preventing the spherical member from falling out of the holding cage; and
a jib stage is formed at the open end of the holding cage in the circumferential direction of the open end for receiving a jig used in the punching process.

2. A universal joint, comprising:
a rotary shaft having a spherical member provided at one end and having a pair of shafts provided on the diameter line of the spherical member; and
a rotating body having guide grooves formed therein for receiving the shafts of the rotary shaft, and a holding cage formed therein for trapping the spherical member, the spherical member rotating about the axis of the shafts and also rotating while tilting the shafts along the guide grooves,
wherein O-ring grooves are formed in the outer periphery surface of the rotating body for receiving an O ring and have open ends formed in parts of the bottom portions of the O-ring grooves to allow the O ring to protrude from the open ends of the ring grooves to the inside of the holding cage, so that the protruding portions of the O ring prevent the spherical member from falling out of the holding cage, and the bottom portion of each of the ring grooves is formed in an arc shape having a curvature greater than the curvature of the inner surface of the holding cage.

3. A universal joint, comprising:
a rotary shaft having a spherical member provided at one end and having a pair of shafts provided on the diameter line of the spherical member; and
a rotating body having guide grooves formed therein for receiving the shafts of the rotary shaft, and a holding cage formed therein for trapping the spherical member, the spherical member rotating about the axis of the shafts and also rotating while tilting the shafts along the guide grooves,
wherein through holes are formed in the rotating body, and balls are respectively inserted in the through holes and protrude from open ends of the through holes to the inside of the holding cage, so that the protruding portions of the balls prevent the spherical member from falling out of the holding cage.
